(19) United States
(12) Patent Application Publication
(10) Pub. No.: US 2016/0107615 A1
(43) Pub. Date: Apr. 21, 2016

(54) WINDSCREEN WIPER DEVICE

(71) Applicant: Federal-Mogul Motorparts Corporation, Southfield, MI (US)

(72) Inventors: William D. Young, III, Waterford, MI (US); Dennis E. Cox, Belleville, MI (US)

(21) Appl. No.: 14/885,297

(22) Filed: Oct. 16, 2015

Related U.S. Application Data
(60) Provisional application No. 62/065,351, filed on Oct. 17, 2014.

(51) Int. Cl. B60S 1/40; B60S 1/38

(52) U.S. Cl. CPC B60S 1/40; B60S 1/38; B60S 1/4048; B60S 2001/4051

(57) ABSTRACT

The windscreen wiper device includes a wiper blade of a flexible material and a connecting device for attachment with an oscillating wiper arm. The connecting device includes a base and a joint part which is pivotally attached with the base. The joint part includes a main body portion which extends in a longitudinal direction between opposite longitudinal ends. Adjacent one of the longitudinal ends, the joint part has a front nose portion. Adjacent the opposite longitudinal end, the joint part includes a rear portion. The rear portion includes a pair of lugs which extend in opposite lateral directions for receiving and engaging legs on the oscillating wiper arm. The lugs are generally cylindrical in shape for allowing more easy rotation of the joint part relative to the legs of the oscillating wiper arm during attachment and detachment of the connecting device to and from the oscillating wiper arm.

### CROSS REFERENCE TO RELATED APPLICATION

This patent application claims the benefit of and priority to U.S. Provisional Patent Application Ser. No. 62/065,351 filed Oct. 17, 2014, the entire disclosure of the application being considered part of the disclosure of this application, and hereby incorporated by reference.

### BACKGROUND OF THE INVENTION

1. Technical Field

This invention relates generally windscreen wiper devices and more particularly to connecting devices for attaching windscreen wiper devices to oscillating wiper arms.

2. Related Art

Passenger vehicles are provided with any one of a range of different styles of oscillating wiper arms including, for example, various sizes of pin-style wiper arms, bayonet-style wiper arms, and top lock-style wiper arms. When the original equipment wiper blades become worn, customers typically look to the aftermarket for replacement wiper blades.

Some aftermarket wiper blades are configured only for attachment to one size and style of wiper arm. However, this approach may be costly to wiper blade manufacturers as separate products and packaging is required for each length and each style of oscillating wiper arm. Other wiper blades are sold with a connecting device including interchangeable parts which can be configured for attachment to two or more different types of oscillating wiper arms. However, such wiper blades are often confusing for customers who are unsure about what type and size of oscillating wiper arms that they have and which of the multiple interchangeable parts to use for their wiper arms.

### SUMMARY OF THE INVENTION AND ADVANTAGES

One aspect of the present invention is related to a windscreen wiper device including a wiper blade of a flexible material and a connecting device for attachment with an oscillating wiper arm. The connecting device includes a base and a joint part which is pivotally attached with the base. The joint part includes a main body portion which extends in a longitudinal direction between opposite longitudinal ends. Adjacent one of the longitudinal ends, the joint part has a front nose portion. Adjacent the opposite longitudinal end, the joint part includes a rear portion. The rear portion includes a pair of lugs which extend in opposite lateral directions for receiving and engaging legs on the oscillating wiper arm. The lugs are generally cylindrical in shape for allowing more easy rotation of the joint part relative to the legs of the oscillating wiper arm during attachment and detachment of the connecting device to and from the oscillating wiper arm.

A method of attaching a windscreen wiper device with an oscillating wiper arm. The method includes the step of providing a windscreen wiper device with a connecting device that has a one-piece joint part with a main body portion which extends in a longitudinal direction and a front nose portion and a rear portion. The front nose portion is pivotable relative to the main body portion at a living hinge, and the rear portion presents a pair of laterally extending lugs with cylindrical shapes. The method proceeds with the step of contacting each of the cylindrical lugs of the joint part with the oscillating wiper arm at two points of contact with one of the points of contact being between the cylindrical lug and a back surface of a leg on the oscillating wiper arm and with the other point of contact being between the cylindrical lug and a lower edge of the oscillating wiper arm. The method continues with the step of pivoting the joint part relative to the oscillating wiper arm about the cylindrical lugs. The method proceeds with the step of lockingly engaging the front nose portion of the joint part with the oscillating wiper arm.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a perspective view of an exemplary windscreen wiper device;

FIG. 2 is a cross-sectional view of the windscreen wiper device of FIG. 1 taken through Line 2-2 of FIG. 1;

FIG. 3 is a an exploded view of a first exemplary embodiment of a connecting device including a base and a joint part for the windscreen wiper device of FIG. 1;

FIG. 4 is an enlarged view of a pair of cylindrical lugs of the joint part of FIG. 3;

FIG. 5 is a side view showing a top lock-style wiper arm in a pre-installation position with the joint part of FIG. 3;

FIG. 6 is a side view showing a top lock with window-style wiper arm in a pre-installation position with the joint part of FIG. 2;

FIG. 6 is a side view showing a top lock-style wiper arm as connected with the joint part of FIG. 2;

FIG. 7 is an enlarged view showing a cylindrical lug in engagement with a top lock-style wiper arm during the installation procedure;

FIG. 8 is an enlarged view showing a cylindrical lug in engagement with a top lock with window-style wiper arm during the installation procedure;

FIG. 9 is a side view showing a top lock with window-style wiper arm as connected with the joint part of FIG. 2;

FIG. 10 is an enlarged view showing a cylindrical lug in engagement with a top lock with window-style wiper arm;

FIG. 11 is a perspective view of a second exemplary embodiment of the joint part;

FIG. 12 is an enlarged view of a cylindrical lug of the joint part of FIG. 12; and

FIG. 13 is a perspective view of a third exemplary embodiment of the joint part.

### DETAILED DESCRIPTION OF PRESENTLY PREFERRED EMBODIMENTS

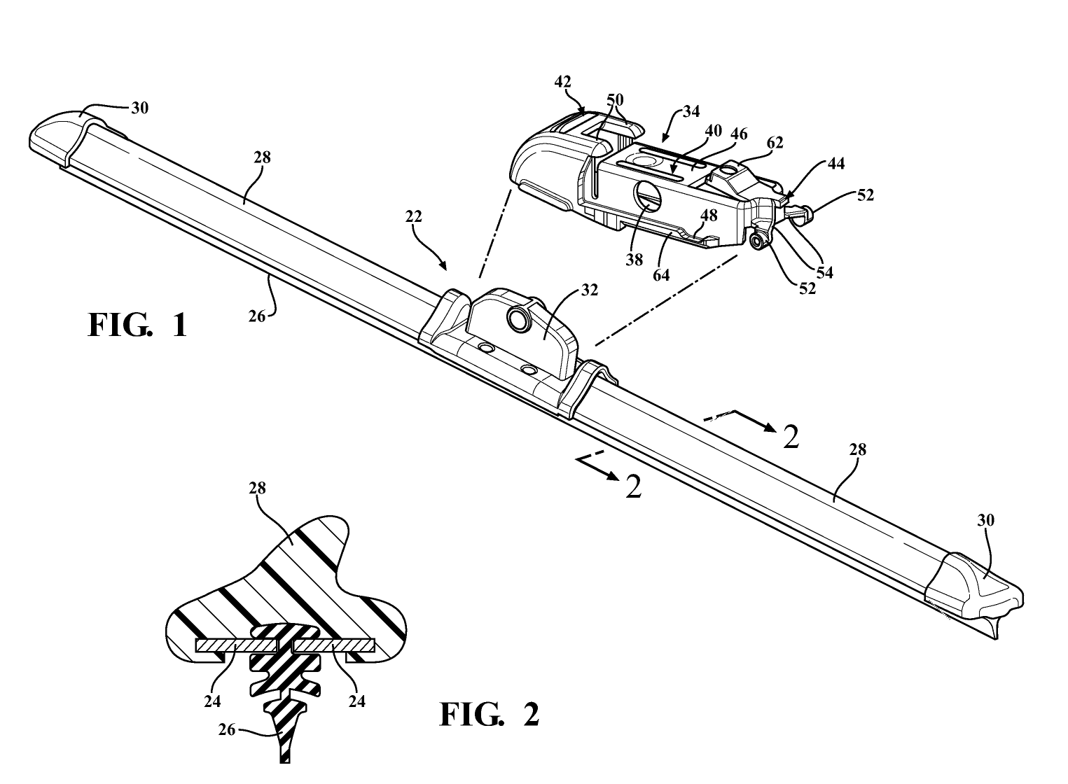

Referring to the Figures, wherein like numerals indicate corresponding parts throughout the several views, a windscreen wiper device 20 with a connecting device 22 that is configured for attachment to a range of different sizes and styles of oscillating wiper arms is generally shown in FIG. 1. Specifically, the connecting device 22 is adapted to provide a more simple connection process with rock and lock style wiper arms, thus making it easier for users to install the windscreen wiper device 20 on their vehicles. Additionally, the connecting device 22 is able to attach with bayonet-style wiper arms, thereby allowing for manufacturing advantages through economies of scale since the manufacturer can produce only one type of connecting device 20 for multiple styles of wiper arms. In the exemplary embodiment, the windscreen wiper device 20 is a beam-style wiper device in that it includes a longitudinally extending carrier element 24 (shown in FIG. 2) which biases a wiper blade 26 (sometimes also known as a wiper element or a wiper strip) into a pre-curved shape and includes a pair of subspoilers 28. The subspoilers 28 which are disposed on opposite longitudinal sides of the connecting device 22 and extend from the connecting device 22 to respective end caps 30. In use, the subspoilers 28 are shaped to limit lift and apply a downforce on the wiper blade 26 when the vehicle is travelling at speed to improve a fluid-tight seal between the wiper blade 26 and a windshield of the vehicle. However, it should be appreciated that the connecting device 22 could also find uses in conventional-style and hybrid-style windscreen wiper devices.

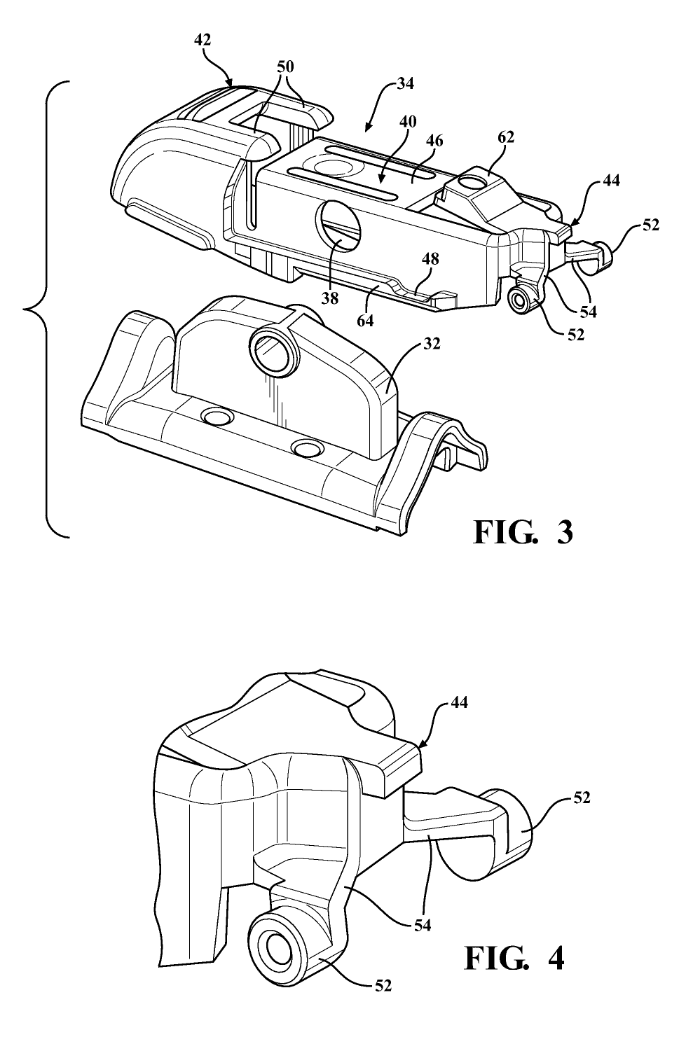

Referring now to FIG. 3, the connecting device 22 is of two pieces including a base 32 and a joint part 34. Each of the base 32 and the joint part 34 is preferably made of a single piece of injection molded plastic. However, it should be appreciated that any suitable material and forming processes may be employed. Subsequent to their separate forming, the base 32 and joint part 34 are pivotally joined together by snappingly engaging cylindrical protrusions 36 on the base 32 with similarly shaped openings 38 on the joint part 34 to allow the joint part 34 to pivot relative to the base 32 about a pivot axis.

The joint part 34 is divided longitudinally into three main portions including a main body portion 40, a front nose portion 42 and a rear portion 44. The main body portion 40 extends between opposite longitudinal ends. As viewed in cross-section, the main body portion 40 is generally U-shaped with a top wall 46 and a pair of laterally spaced sidewalls 48.

The front nose portion 42 of the joint part 34 is located at one longitudinal end of the main body portion 40 and is spaced longitudinally from the pivot axis. The front nose portion 42 includes a pair of fingers 50 which extend longitudinally from an upper surface of the front nose portion 42 for releasably engaging with a top surface of top lock-style, top lock with window-style and bayonet-style wiper arms as discussed in further detail below. The front nose portion 42 is connected to the main body portion 40 at a lower end of the nose portion 42 via a first living hinge which allows the front nose portion 42 to flex forwardly and backwardly for releasably locking the fingers 50 with the top surface of the respective wiper arm. The front nose portion 42 also includes a U-shaped recess which separates the fingers 48.

Referring still to FIG. 3, the rear portion 44 of the joint part 34 is spaced longitudinally from the front nose portion 42 and includes a pair of generally cylindrically-shaped lugs 52 which are spaced longitudinally from the back end of the main body portion 40 and extend away from one another in opposite lateral directions. In this exemplary embodiment, the cylindrical lugs 52 are solidly (i.e., non-resiliently) connected with the main body portion 40 via bridge support structures 54 which extend longitudinally from a longitudinal end of the main body portion 40. The exemplary bridge support structures 54 diverge away from one another away from the main body portion 40.

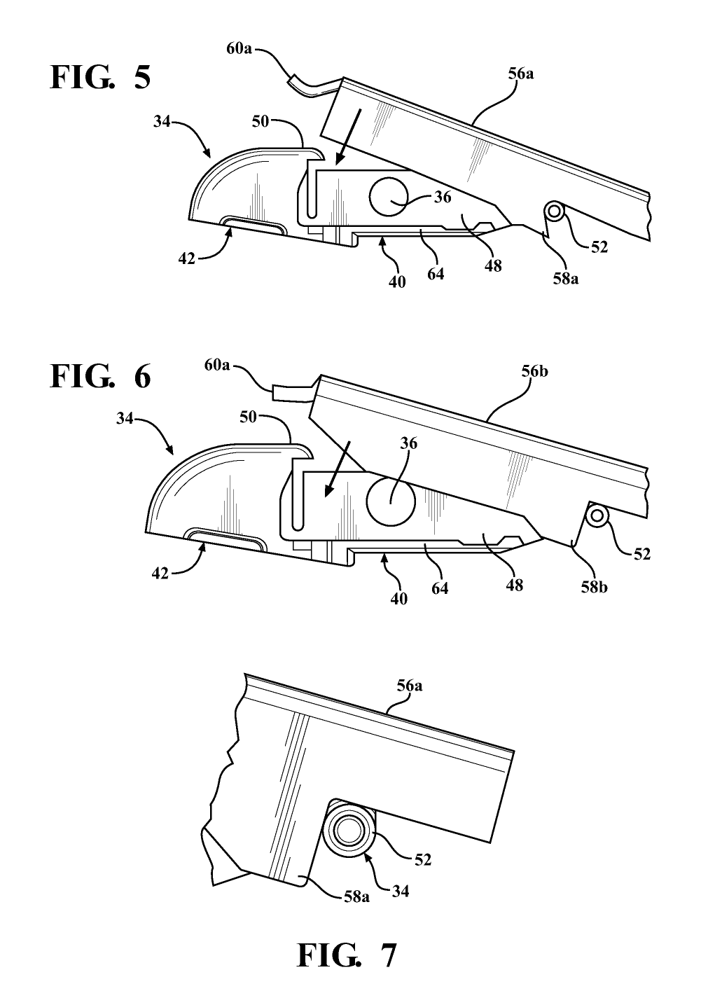

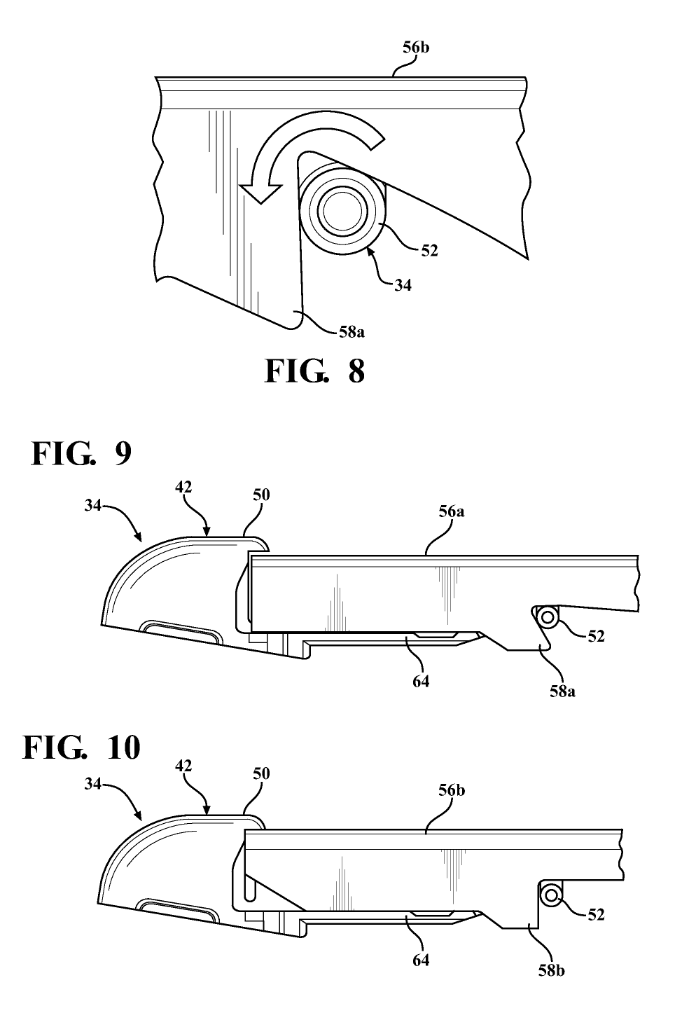

Referring now to FIGS. 5-10, the connecting process of attaching the joint part 34 with a top lock-style wiper arm 56a (FIGS. 5, 7 and 9) and a top lock with window-style wiper arm 56b (FIGS. 6, 8 and 10) is shown. The connecting process starts by angling the joint part 34 relative to the wiper arm 56a, 56b and contacting each of the cylindrical lugs 52 with pack the wiper arm 56a, 56b at two points of contact. Specifically, one of the points of contact is between an outer surface of the lug 52 and a back surface of a downwardly extending leg 58a, 58b on the respective wiper arm 56a, 56b. As shown in FIGS. 7 and 8, the joint part 34 is then rotated or pivoted relative to the wiper arm 56a, 56b. A tongue 60a, 60b on the front of the wiper arm 56a, 56b passes through the U-shaped opening between the fingers 50 as the front nose portion 42 hinges forwardly and snaps to lockingly engage the fingers 50 with a top wedge of the wiper arm 56a, 56b. FIGS. 9 and 10 show the joint part 34 properly locked with the wiper arms 56a, 56b. The circular outer surfaces of the cylindrical lugs 52 smoothen the pivoting of the joint part 34 relative to the wiper arm 56a, 56b and provide a more natural feel to the customer as compared to the connecting devices of other wiper devices.

Disconnecting the wiper arm 56a, 56b from the joint part 34 involves urging the front nose portion 42 forwardly to disengage the fingers 50 on the nose portion 42 from the top edge of the wiper arm 56a, 56b. The joint part 34 and wiper arm 56a, 56b may then be pivoted relative to one another in the reverse direction from the installation. During both the installation and the detachment processes, the cylindrical lugs 52 remain in their respective positions and do not resiliently move.

Referring back to FIG. 3, the exemplary joint part 34 also includes features for connection with a bayonet-style wiper arm (not shown). Specifically, the top wall 46 of the main body portion 40 includes a resilient, or spring loaded tab with a button 62 for snappingly engaging with an opening in a bayonet-style wiper arm. The main body portion 40 also presents at least one rail 62 for receiving a lower flange of the bayonet-style wiper arm to additionally lock the bayonet-style wiper arm with the joint part 34.

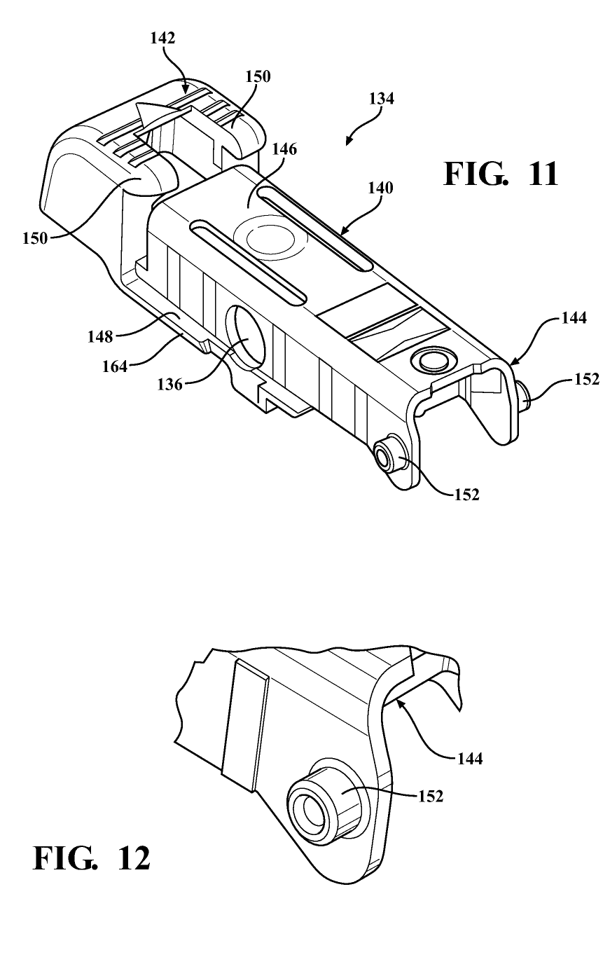

A second exemplary embodiment of the joint part 134 is shown in FIGS. 11 and 12 with like numerals, separated by a factor of 100, indicating corresponding parts with the above-described embodiment. This exemplary embodiment is distinguished from the above-described embodiment in that it lacks the button and thus is not configured for attachment with bayonet-style wiper arms and also in that the laterally extending and cylindrically shaped lugs 152 extend directly from the side walls 148 of the joint part 134. That is, the top wall 146 and side walls 148 of the main body portion 140 extend to the rear portion 144 and the rear portion 144 lacks the bridge support structures of the above-described embodiment.

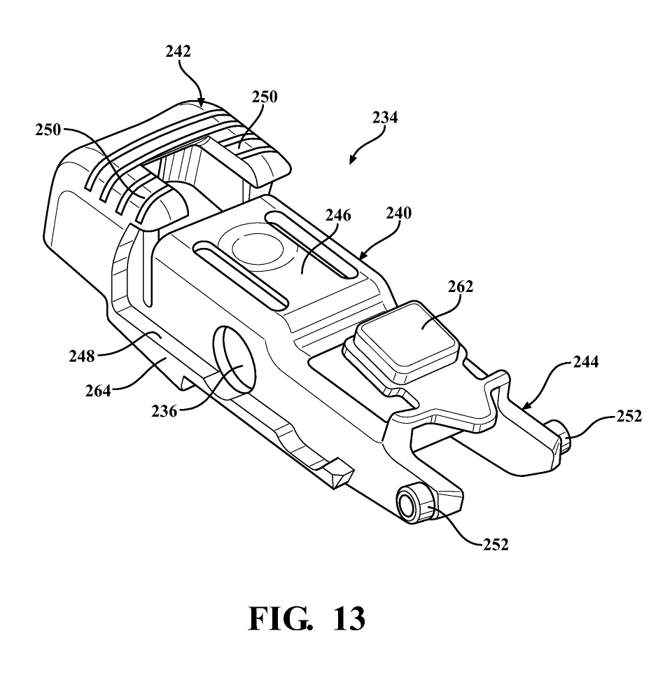

A third exemplary embodiment of the joint part 234 is generally shown in FIG. 13 with like numerals, separated by a factor of 200, indicating corresponding parts with the first exemplary embodiment. This embodiment includes features of both the first and second exemplary embodiments described above. For example, the third embodiment includes the button 262 for attaching with bayonet-style wiper arms of the first exemplary embodiment and the cylindrical lugs 252 are on the side walls 248 as with the second embodiment described above.

Obviously, many modifications and variations of the present invention are possible in light of the above teachings. It is, therefore, to be understood that within the scope of the appended claims, the invention may be practiced otherwise than as specifically described.

What is claimed is:

1. A windscreen wiper device, comprising:
a wiper blade of a flexible material;
connecting device for attachment with an oscillating wiper arm;
said connecting device including a base and a joint part which is pivotably attached with said base;
said joint part including a main body portion which extends in a longitudinal direction between opposite longitudinal ends, said joint part further including a front nose portion positioned adjacent one longitudinal end of said main body portion, and said joint part further including a rear portion positioned at an opposite longitudinal end of said main body portion from said front nose portion;
said rear portion including a pair of lugs which extend in opposite lateral directions for receiving legs on the oscillating wiper arm; and
said lugs being generally cylindrical in shape for allowing easy rotation of said joint part relative to the legs of the oscillating wiper arm during attachment and detachment of said connecting device with the oscillating wiper arm.

2. The windscreen wiper device as set forth in claim 1 wherein said lugs are connected with said main body portion via at least one bridge.

3. The windscreen wiper device as set forth in claim 2 wherein said at least one bridge is a pair of bridges which diverge away from one another from said main body portion.

4. The windscreen wiper device as set forth in claim 1 wherein said main body portion and said rear portion are generally U-shaped with a top wall and a pair of side walls and wherein said cylindrical lugs extend laterally from said side walls.

5. The windscreen wiper device as set forth in claim 1 wherein said front nose portion includes a pair of longitudinally extending fingers for lockingly engaging a top edge of at least one style of oscillating wiper arm.

6. The windscreen wiper device as set forth in claim 5 wherein said front nose portion is connected with said main body portion via a living hinge for allowing said front nose portion to pivot relative to said main body portion.

7. The windscreen wiper device as set forth in claim 6 wherein said fingers of said front nose portion are spaced laterally from one another by a U-shaped opening for allowing a tongue on one style of oscillating wiper arm to pass between said fingers during attachment and detachment of said joint part with the oscillating wiper arm.

8. The windscreen wiper device as set forth in claim 1 wherein said main body portion has a top wall with a resilient tab and a button formed therein for lockingly engaging within an opening of one style of oscillating wiper arm.

9. A method of attaching a windscreen wiper device with an oscillating wiper arm, comprising the steps of:
providing a windscreen wiper device with a connecting device that has a one-piece joint part with a main body portion which extends in a longitudinal direction and a front nose portion and a rear portion, the front nose portion being pivotable relative to the main body portion at a living hinge, and the rear portion presenting a pair of laterally extending lugs with cylindrical shapes;
contacting each of the cylindrical lugs of the joint part with the oscillating wiper arm at two points of contact with one of the points of contact being between the cylindrical lug and a back surface of a leg on the oscillating wiper arm and with the other point of contact being between the cylindrical lug and a lower edge of the oscillating wiper arm;
pivoting the joint part relative to the oscillating wiper arm about the cylindrical lugs; and
lockingly engaging the front nose portion of the joint part with the oscillating wiper arm.
